(19) United States
(12) Patent Application Publication
(10) Pub. No.: US 2012/0042347 A1
(43) Pub. Date: Feb. 16, 2012

(54) INFORMATION PROCESSING DEVICE, INFORMATION PROCESSING METHOD, AND INFORMATION PROCESSING SYSTEM

(75) Inventor: Kazutaka Yasuda, Tokyo (JP)

(73) Assignee: SONY CORPORATION, Tokyo (JP)

(21) Appl. No.: 13/196,070

(22) Filed: Aug. 2, 2011

(30) Foreign Application Priority Data
Aug. 11, 2010 (JP) P2010-180314

(51) Int. Cl. H04N 21/433

(52) U.S. Cl. 725/89

(57) ABSTRACT

An information processing device, includes a display portion that displays video content that has been received from a server that stores the video content, a storage portion that stores a playback interruption position for the video content, and a video output portion that, in a case where a video acquisition request is received from another device that will restart playback of the video starting from the playback interruption position, acquires the video content from the server, starting from the playback interruption position, and transmits the acquired video content to the other device.

### CROSS-REFERENCE TO RELATED APPLICATION

The present application claims priority from Japanese Patent Application No. JP 2010-180314 filed in the Japanese Patent Office on Aug. 11, 2010, the entire content of which is incorporated herein by reference.

### BACKGROUND OF THE INVENTION

The present disclosure relates to an information processing device, an information processing method, and an information processing system.

Technologies are known that switch devices and provide sequential information signals in a system of devices that are connected through a network, such as the technology described in Japanese Patent Application Publication No. JP-A-10-164449, for example.

### SUMMARY OF THE INVENTION

However, with the known technologies described above, in order for the devices to be switched and the sequential information signals to be provided, the devices within the system must be equipped with this function. Therefore, with home network technologies that conform to the already widely used Digital Living Network Alliance (DLNA) standard or the like, it is difficult to switch the devices and perform playback.

Accordingly, in light of the problem described above, the present disclosure provides an information processing device, an information processing method, and an information processing system that are novel and improved and that, with minimal change to the system, are capable of allowing an existing network device to which a switch has been made to perform playback that starts from a position at which playback was interrupted before the device was switched.

According to an embodiment of the present invention, there is provided an information processing device, includes a display portion that displays video content that has been received from a server that stores the video content, a storage portion that stores a playback interruption position for the video content, and a video output portion that, in a case where a video acquisition request is received from another device that will restart playback of the video starting from the playback interruption position, acquires the video content from the server, starting from the playback interruption position, and transmits the acquired video content to the other device.

According to another embodiment of the present invention, there is provided an information processing device, includes a display portion that displays video content that has been received from a server that stores the video content, a playback interruption position acquisition portion that acquires a playback interruption position for the video content, and a communication portion that, in order to restart playback of the video by another device, starting from the playback interruption position, transmits information on the playback interruption position to a controller that operates the other device.

According to another embodiment of the present invention, there is provided an information processing method, includes displaying video content that has been received from a server that stores the video content, storing a playback interruption position for the video content, and acquiring the video content from the server, starting from the playback interruption position, in a case where a video acquisition request is received from another device that will restart playback of the video starting from the playback interruption position, and transmitting the acquired video content to the other device.

According to another embodiment of the present invention, there is provided an information processing method, includes displaying video content that has been received from a server that stores the video content, acquiring a playback interruption position for the video content, and a communication portion that, in order to restart playback of the video by another device, starting from the playback interruption position, transmitting information on the playback interruption position to a controller that operates another device, in order to restart playback of the video by the other device, starting from the playback interruption position.

According to another embodiment of the present invention, there is provided an information processing system, includes a server that stores video content, a first information processing device that includes a display portion that displays video content that has been received from the server, a storage portion that stores a playback interruption position for the video content, and a video output portion that, in a case where a video acquisition request is received from a second information processing device that will restart playback of the video starting from the playback interruption position, acquires the video content from the server, starting from the playback interruption position, and transmits the acquired video content to the second information processing device, and the second information processing device that receives the video content from the first information processing device, starting from the playback interruption position, and that performs the playback of the video starting from the playback interruption position.

According to another embodiment of the present invention, there is provided an information processing system, includes a server that stores video content, a first information processing device that includes a display portion that displays video content that has been received from the server, a playback interruption position acquisition portion that acquires a playback interruption position for the video content, and a communication portion that, in order to restart playback of the video by a second information processing device, starting from the playback interruption position, transmits information on the playback interruption position, a controller that receives the information on the playback interruption position and transmits the information on the playback interruption position to the second information processing device, and the second information processing device that receives the information on the playback interruption position from the controller and that receives the video content from the server, starting from the playback interruption position, based on the information on the playback interruption position.

According to the present disclosure, it is possible, with minimal change to the system, for an existing network device to which a switch has been made to perform playback that starts from a position at which playback was interrupted before the device was switched.

### BRIEF DESCRIPTION OF THE DRAWINGS

FIG. 1 is a block diagram that shows a presumed configuration of a system of devices that are connected to a network, according to an embodiment of the present disclosure;

FIG. 2 is a sequence chart that shows an operation of the system of the devices that are connected to a network, as shown in FIG. 1;

FIG. 3 is a sequence chart that shows an operation of the system of the devices that are connected to a network, as shown in FIG. 1;

FIG. 4 is a sequence chart that shows an operation of the system of the devices that are connected to a network, as shown in FIG. 1;

FIG. 5 is a sequence chart that shows an operation of the system of the devices that are connected to a network, as shown in FIG. 1;

FIG. 6 is a sequence chart that shows a case in which playback by a renderer has been interrupted;

FIG. 7 is a sequence chart that shows a case in which playback by a player has been interrupted, in the case of a two-device model that is shown in FIG. 4;

FIG. 8 is a sequence chart that shows a case in which a video that was being played back by a player 9 is played back by the player 9 itself, after having been interrupted, in the case of the two-device model;

FIG. 9 is a schematic diagram that shows a configuration of a system that uses a method that broadcasts streaming data and also shows an overview of processing;

FIG. 10 is a block diagram that shows a configuration of the system of the devices that are connected to a network in a case where the system and the devices use the method that broadcasts streaming data;

FIG. 11 is a sequence chart that shows a method for implementing playback of a video for which playback has been interrupted, using a renderer 6 that is shown in FIGS. 9 and 10;

FIG. 12 is a sequence chart that shows the method for implementing playback of a video for which playback has been interrupted, using the renderer 6 that is shown in FIGS. 9 and 10;

FIG. 13 is a sequence chart that shows a method for implementing playback of a video for which playback has been interrupted, using the player 9 that was explained by FIG. 9;

FIG. 14 is a schematic diagram that shows a configuration of a system that uses a method that utilizes metadata and also shows an overview of processing;

FIG. 15 is a block diagram that shows a configuration of the system of the devices that are connected to a network in a case where the system and the devices use the method that utilizes metadata;

FIG. 16 is a sequence chart that shows processing in a case in which video position identification information acquisition portions have been added to each of a renderer and a controller;

FIG. 17 is a sequence chart that shows processing in a case in which video position identification information acquisition portions 28, 100 have respectively been added to the renderer and a player; and

FIG. 18 is a schematic diagram that shows a comparison of a method that broadcasts streaming data and a method that appends to the metadata information that pertains to playback that starts from the position where playback was interrupted.

### DETAILED DESCRIPTION OF EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the explanation will be in the order shown below.

1. Presumed technology

2. Method that broadcasts streaming data

3. Method that adds information on resuming playback to metadata

### 1. Presumed Technology

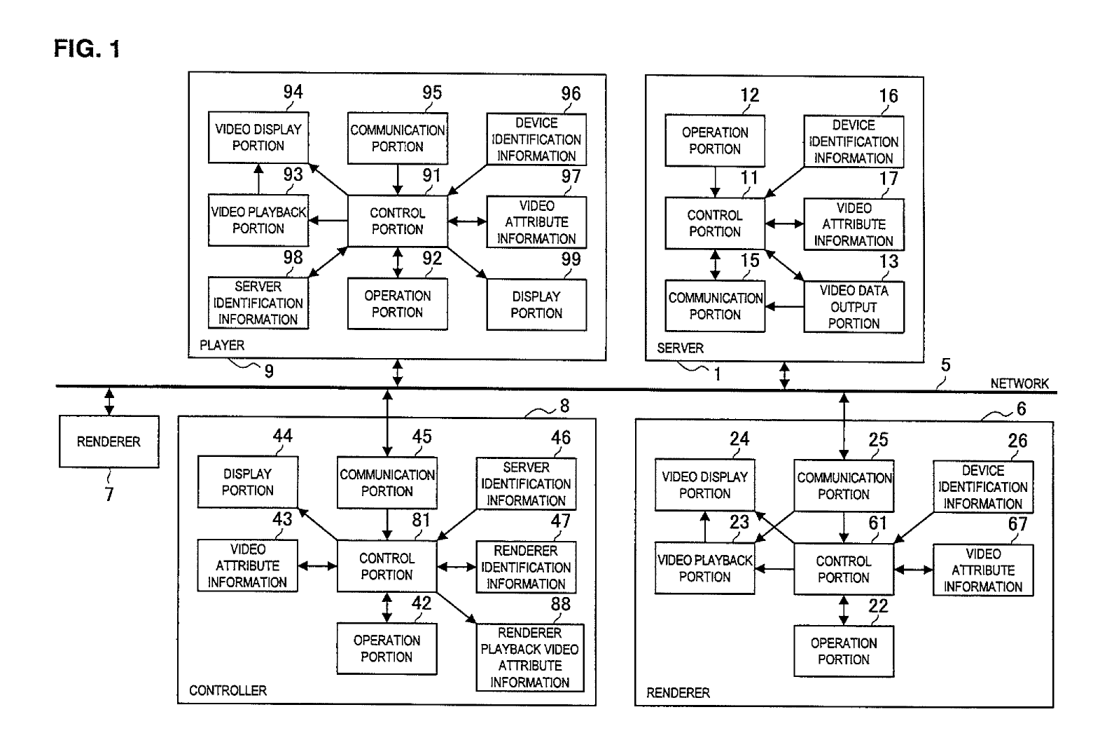

FIG. 1 is a block diagram that shows a presumed configuration of a system of devices that are connected to a network, according to an embodiment of the present disclosure. As shown in FIG. 1, the system includes a server 1, a renderer 6, a renderer 7, a controller 8, and a player 9. The server 1, the renderer 6, the renderer 7, the controller 8, and the player 9 are connected to one another through a network 5 that is a local area network (LAN) or the like.

The server 1 stores video content, for example, and has a function transmits the video content to another device through the network 5, making it possible for the other device to play back the video content. As an example, the server 1 includes a digital media server (DMS) function that conforms to the Digital Living Network Alliance (DLNA) standard.

The renderer 6 and the renderer 7 have functions that receive the transmission of the video content, for example, from the server 1 through the network 5 and that play back the video content. As an example, each of the renderer 6 and the renderer 7 includes a digital media renderer (DMR) function that conforms to the DLNA standard.

The controller 8 has functions that determine what video content that the server 1 has will be played back by one of the renderer 6 and the renderer 7 and that control the playing, stopping, and the like by the renderer 6 and the renderer 7. As an example, the controller 8 includes a digital media controller (DMC) function that conforms to the DLNA standard. The controller 8 can be configured from a mobile device such as a mobile telephone or the like, for example.

The player 9 has functions that determine what video content that the server 1 has will be played back and that control the playing, stopping, and the like of the video content. As an example, the player 9 includes a digital media player (DMP) function that conforms to the DLNA standard. The player 9 also has functions of the renderers 6, 7 and the controller 8 that will be described later.

Next, the configuration of the various structural elements that are shown in FIG. 1 will be explained. First, the configuration of the server 1 will be explained. As shown in FIG. 1, the server 1 is configured such that it includes a control portion 11, an operation portion 12, a video data output portion 13, a communication portion 15, device identification information 16, and video attribute information 17. The control portion 11 is configured from a central processing unit (CPU) and the like, for example, and performs control of the entire server 1. The operation portion 12 includes a Play switch, a Stop switch, and the like that are not shown in the drawings. The operation portion 12 receives commands from a user to play and stop the video data that are stored in the server 1 and transmits the commands to the control portion 11. The communication portion 15 receives video data acquisition requests from other devices and transmits the requests to the control portion 11. The control portion 11 issues a command to the video data output portion 13 to transmit to the communication portion 15 the video data that correspond to the video data acquisition request from the other device. The video data output portion 13 includes a hard disk, a memory, and the like that are not shown in the drawings, and in accordance with the command from the control portion 11, it transmits the designated video data to the communication portion 15. The communication portion 15 receives the video data that have been transmitted from the video data output portion 13 and transmits the video data to the other device through the network 5. The device identification information 16 and the video attribute information 17 are information that is stored in a memory (a storage portion) or the like with which the server 1 is provided. The device identification information 16 is information that is unique to the server 1 and that makes it possible for various types of devices that are connected to the network 5 to identify the server 1. The video attribute information 17 is attribute information, such as the titles, running times, and the like for all of the video content that the video data output portion 13 stores. Based on a command from the control portion 11, the video attribute information is transmitted to the controller 8 through the control portion 11 and the communication portion 15.

Next, the configuration of the renderer 6 will be explained. As shown in FIG. 1, the renderer 6 is configured such that it includes a control portion 61, an operation portion 22, a video playback portion 23, a video display portion 24, a communication portion 25, device identification information 26, and video attribute information 67. The control portion 61 is configured from a central processing unit (CPU) and the like, for example, and performs control of the entire renderer 6. The operation portion 22 includes a Play switch, a Stop switch, and the like that are not shown in the drawings. The operation portion 22 receives commands from the user to play and stop the video content that has been transmitted from an external source and transmits the commands to the control portion 61. The communication portion 25 issues a video data acquisition request to the server 1 in accordance with a command from the control portion 61. The communication portion 25 transmits to the control portion 61 a video data acquisition result for the video data acquisition request, then transmits acquired video data to the video playback portion 23 in accordance with a command from the control portion 61. The video playback portion 23 receives a playback command from the control portion 61, decodes the video data that have been transmitted from the communication portion 25, and outputs the video to the video display portion 24. The video display portion 24 displays the video from the video playback portion 23. The device identification information 26 and the video attribute information 67 are information that is stored in a memory (a storage portion) or the like with which the renderer 6 is provided. The device identification information 26 is information that is unique to the renderer 6 and that makes it possible for various types of devices that are connected to the network 5 to identify the renderer 6. The video attribute information 67 is attribute information, such as the titles, running times, and the like for the video content that the video playback portion 23 plays back. The video attribute information 67 is acquired from another device through the communication portion 65 and the control portion 61. The renderer 7 is configured in the same manner as the renderer 6.

Next, the configuration of the controller 8 will be explained. The controller 8 is configured such that it includes a control portion 81, an operation portion 42, video attribute information 43, a display portion 44, a communication portion 45, server identification information 46, renderer identification information 47, and renderer playback video attribute information 88. The control portion 81 is configured from a central processing unit (CPU) and the like, for example, and performs control of the entire controller 8. The operation portion 42 includes content selection switch, a Play switch, a Stop switch, and the like that are not shown in the drawings. The operation portion 42 receives commands from the user to acquire the video attribute information 17 for the server 1 and to play and stop designated video data, and transmits the commands to the control portion 81. The video attribute information 43, the server identification information 46, the renderer identification information 47, and the renderer playback video attribute information 88 are information that is stored in a memory (a storage portion) or the like with which the controller 8 is provided. The video attribute information 43 is one of all and a part of the video attribute information 17 for the server 1 that is acquired through the control portion and the communication portion 45. The video attribute information 43 is displayed in the display portion 44 through the control portion 81 and is stored and utilized for selecting the video content on the server 1. The display portion 44 displays one of all and a part of the video attribute information 43, in accordance with a command from the control portion 81.

The communication portion 45, upon receiving a command from the control portion 81, acquires the video attribute information 17 from the server 1 and transmits the video attribute information 17 to the control portion 81. In addition, upon receiving a command from the control portion 81, the communication portion 45 issues commands to one of the renderer 6 and the renderer 7 to play back and stop video data from the server 1. The server identification information 46 is acquired by receiving and copying the unique identification information for the server 1 (the device identification information 16) through the communication portion 45 and the control portion 81, after which it is stored. The renderer identification information 47 is acquired by receiving and copying the unique identification information for the renderer and the renderer 7 (the device identification information 26) through the communication portion 45 and the control portion 81, after which it is stored. The renderer playback video attribute information 88 is one of all and a part of the attribute information, such as the title, the running time, and the like, for one of the video content that is planned to be played back and the video content that is currently being played back by one of the renderer 6 and the renderer 7. The attribute information for the video content, such as the title, the running time, and the like, is stored as the video attribute information 43. The renderer playback video attribute information 88 is transmitted to one of the renderer 6 and the renderer 7 through the control portion 81 and the communication portion 45.

Next, the configuration of the player 9 will be explained. The player 9 is configured such that it includes a control portion 91, an operation portion 92, a video playback portion 93, a video display portion 94, a communication portion 95, device identification information 96, video attribute information 97, server identification information 98, and a display portion 99. The control portion 91 is configured from a central processing unit (CPU) and the like, for example, and performs control of the player 9. The operation portion 92 includes content selection switch, a Play switch, a Stop switch, and the like that are not shown in the drawings. The operation portion 92 receives commands from the user to acquire the video attribute information 17 for the server 1 and to play and stop designated video data, and transmits the commands to the control portion 91. The device identification information 96, the video attribute information 97, and the server identification information 98 are information that is stored in a memory (a storage portion) or the like with which the player 9 is provided. The video attribute information 97 is one of all and a part of the video attribute information 17 for the server 1 that is acquired through the control portion 91 and the communication portion 95. The video attribute information 97 is displayed in the display portion 99 through the control portion 91 and is stored and utilized for selecting the video content on the server 1. The display portion 99 displays one of all and a part of the video attribute information 97, in accordance with a command from the control portion 91. The video playback portion 93, upon receiving a playback command from the control portion 91, decodes the video data from the communication portion 95 and outputs the video to the video display portion 94. The video display portion 94 displays the video from the video playback portion 93.

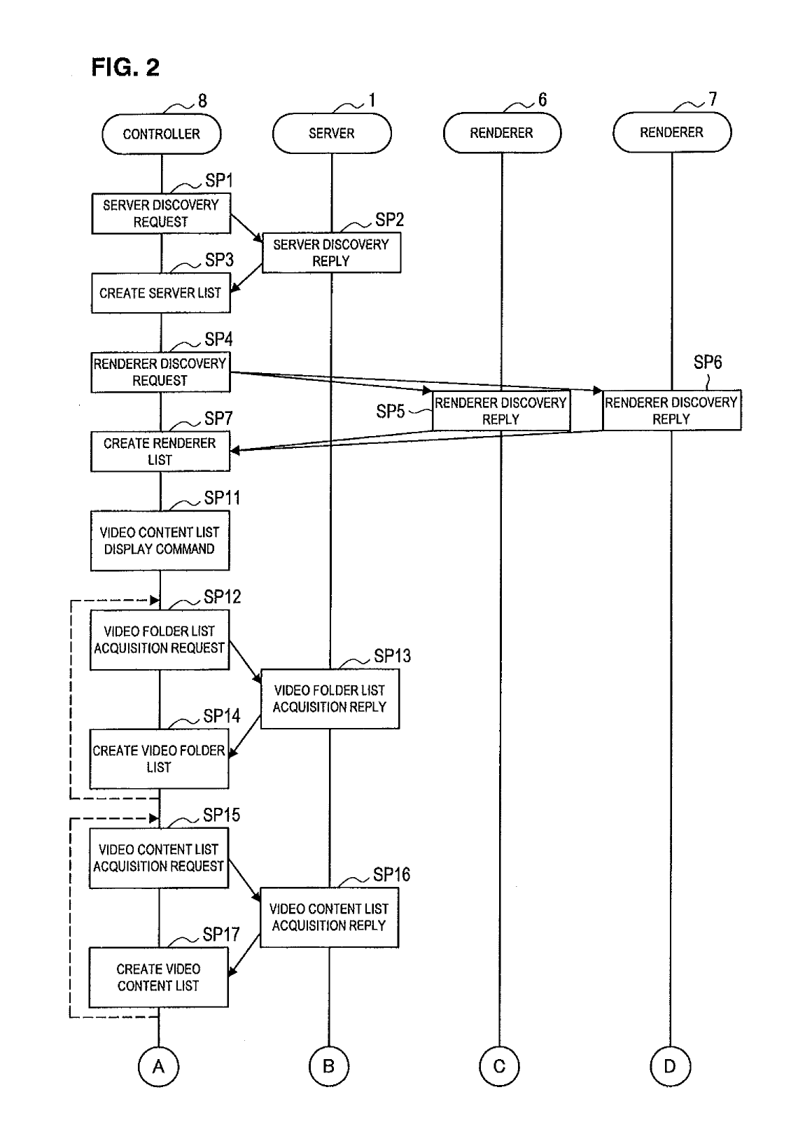

Next, the operation of the system of the devices that are connected to the network in FIG. 1 will be explained based on sequence charts that are shown in FIGS. 2 to 5. FIG. 2 shows a case in which the system is configured as a model that includes the controller 8, the server 1, and the renderers 6, 7 (hereinafter called the three-device model). Steps SP1 to SP7 in FIG. 2 are performed automatically when the power supply to the controller 8 is turned on.

At Step SP1, the control portion 81 of the controller 8 issues a request to discover the server 1 that is connected to the network 5, and a server discovery protocol is broadcast on the network 5 through the communication portion 45. In the DLNA standard, the Simple Service Discovery Protocol (SSDP) is used.

At Step SP2, the communication portion 15 of the server 1 acquires the server discovery protocol that is broadcast on the network 5 and transmits it to the control portion 11. The control portion 11 creates a reply packet that includes the device identification information 16, then transmits the reply packet to the controller 8 through the communication portion 15.

At Step SP3, the communication portion 45 of the controller 8 acquires the reply to the server discovery request from the server 1 and transmits the reply to the control portion 81. The control portion 81 acquires the device identification information 16 for the server 1 and stores it as the server identification information 46.

At Step SP4, the control portion 81 of the controller 8 issues a request to discover the renderers that are connected to the network 5, and a renderer discovery protocol is broadcast on the network 5 through the communication portion 45.

At Step SP5, the communication portion 25 of the renderer 6 acquires the renderer discovery protocol that is broadcast on the network 5 and transmits it to the control portion 61. The control portion 61 creates a reply packet that includes the device identification information 26, then transmits the reply packet to the controller 8 through the communication portion 25. At Step SP6, the renderer 7 carries out the same sort of reply procedure as the renderer 6 did at Step SP5.

At Step SP7, the communication portion 45 of the controller 8 acquires from the renderer 6 and the renderer 7 the replies to the renderer discovery request and transmits the replies to the control portion 81. The control portion 81 acquires the device identification information 26 for the renderer 6 and the renderer 7 and stores it as the renderer identification information 47.

Through the processing at Step SP1 to Step SP7 described above, the controller 8 enters a state in which it is aware of the presence of the server 1, the renderer 6, and the renderer 7 that are connected to the network 5.

Steps SP11 to SP18 are processing for selecting the video content to be played back. First, at Step SP11, the user operates the operation portion 42 of the controller 8 to issue a command to display a list of the video content on the server 1.

Next, at Step SP12, the control portion 81 of the controller 8, in accordance with a control signal from the operation portion 42 that is based on the user's command, transmits to the server 1 through the communication portion 45 a request to acquire a list of video folders on the server 1. In the DLNA standard, the Simple Object Access Protocol (SOAP) is used, and specifically, the attribute information for the video content can be acquired by using a command called CDS: Browse.

At Step SP13, the communication portion 15 of the server 1 acquires the request to acquire the list of video folders from the controller 8 and transmits the request to the control portion 11. Many separate items of video content exist on the server 1, and the content items are grouped into folders and stored. Based on the video attribute information 17, the control portion 11 acquires information on the video folders that the server 1 has. The control portion 11 then transmits that information as a video folder list acquisition reply to the controller 8 through the communication portion 15.

At Step SP14, the communication portion 45 of the controller 8 transmits the video folder list acquisition reply from the server 1 to the control portion 81, and the control portion 81 displays the names and the like for the video folders on the display portion 44. The user looks at the display on the display portion 44 and uses the operation portion 42 to select the video folder he wants to see. In a case where there are lower-level folders within the folder that the user has selected, the processing from Step SP12 to Step SP14 is repeated, and a list of the lower-level folders is displayed.

At Step SP15, the control portion 81 of the controller 8, in accordance with a control signal from the operation portion 42 that is based on the user's command, transmits to the server 1 through the communication portion 45 a request to acquire a list of the video content on the server 1.

At Step SP16, the communication portion 15 of the server 1 acquires the request to acquire the list of the video content from the controller 8 and transmits the request to the control portion 11. Based on the video attribute information 17, the control portion 11 acquires information on the video content that the server 1 has. The control portion 11 then transmits that information as a video content list acquisition reply to the controller 8 through the communication portion 15.

At Step SP17, the communication portion 45 of the controller 8 transmits the video content list acquisition reply from the server 1 to the control portion 81, and the control portion 81 displays the titles and the like for the video content on the display portion 44. The user can look at the display on the display portion 44 and use the operation portion 42 to select the video content he wants to see. In a case where a large amount of the video content is stored on the server 1 and the information for all of the content cannot be displayed at the same time, the processing from Step SP15 to Step SP17 is repeated.

At Step SP18, the user uses the operation portion 42 to select the video content he wants to play back. The video content that the user wants to play back is set from the controller 8 by the processing from Step SP11 to Step SP18 that is described above.

At Step SP21, the control portion 81 displays a list the renderers that are playback destinations. As examples, in this case, the renderers 6, 7 are displayed as the renderers that are the playback destinations. Next, at Step SP22, the user sets the playback destination renderer by operating the operation portion 42. In this example, the renderer 6 is designated as the playback destination renderer.

Next. at Step SP23, the attribute information for the content that will be played back is designated. The attribute information designation is transmitted to the playback destination renderer 6, and at Step SP24, the renderer 6 stores the attribute information for the content that will be played back and transmits to the controller 8 a reply to the attribute information designation.

At Step SP25, the controller 8 issues a playback request to the renderer 6. At Step SP26, a video acquisition request is transmitted from the renderer 6 to the server 1. The video acquisition request includes the attribute information for the content that will be played back. At Step SP27, a reply to the video acquisition request is transmitted from the server 1 to the renderer 6. Thus the video content that corresponds to the attribute information for the content that will be played back is transmitted from the server 1 to the renderer 6 as the reply to the video acquisition request. At Step SP28, the playback of the video content is performed by the renderer 6. At Step SP31, the power supply for the controller 8 is turned off.

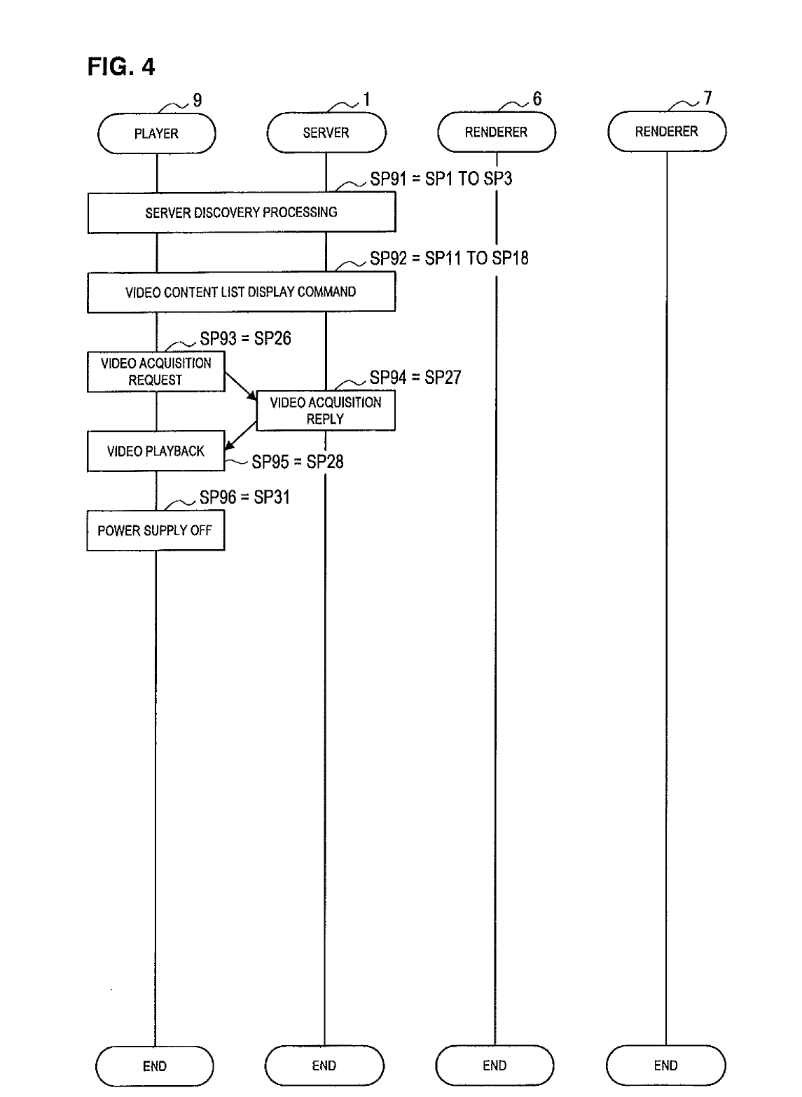

FIG. 4 is a sequence chart that shows the relationship between the player 9 and the server 1. FIG. 4 shows a case in which the system is configured as a model that includes the player 9, the server 1, and the renderers 6, 7 (hereinafter called the two-device model). As explained previously, the player 9 is provided with the functions of the controller 8 and the functions of the renderers 6, 7. At Step SP91, the same sort of server discovery processing is performed as was performed at Step SP1 to Step SP3 in FIG. 2. At Step SP92, the same sort of video content list display processing is performed as was performed at Step SP11 to Step SP18. Step SP93, Step SP94, and Step SP95 are the same as Step SP26, Step SP27, and Step SP28, respectively. When the video playback ends, the power supply for the player 9 is turned off at Step SP31. Because the player 9 is provided with the functions of the controller 8, the player 9 is able to perform the setting of the content to be played back, the playback request, and the video acquisition request by itself.

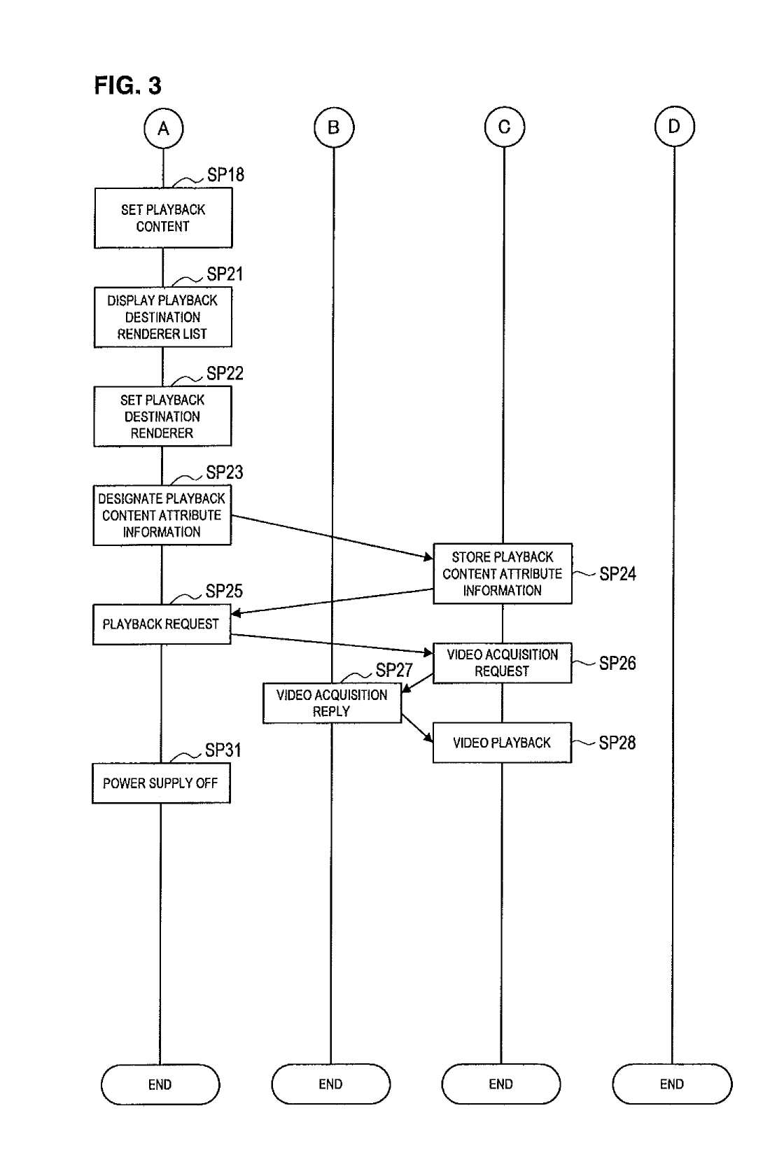

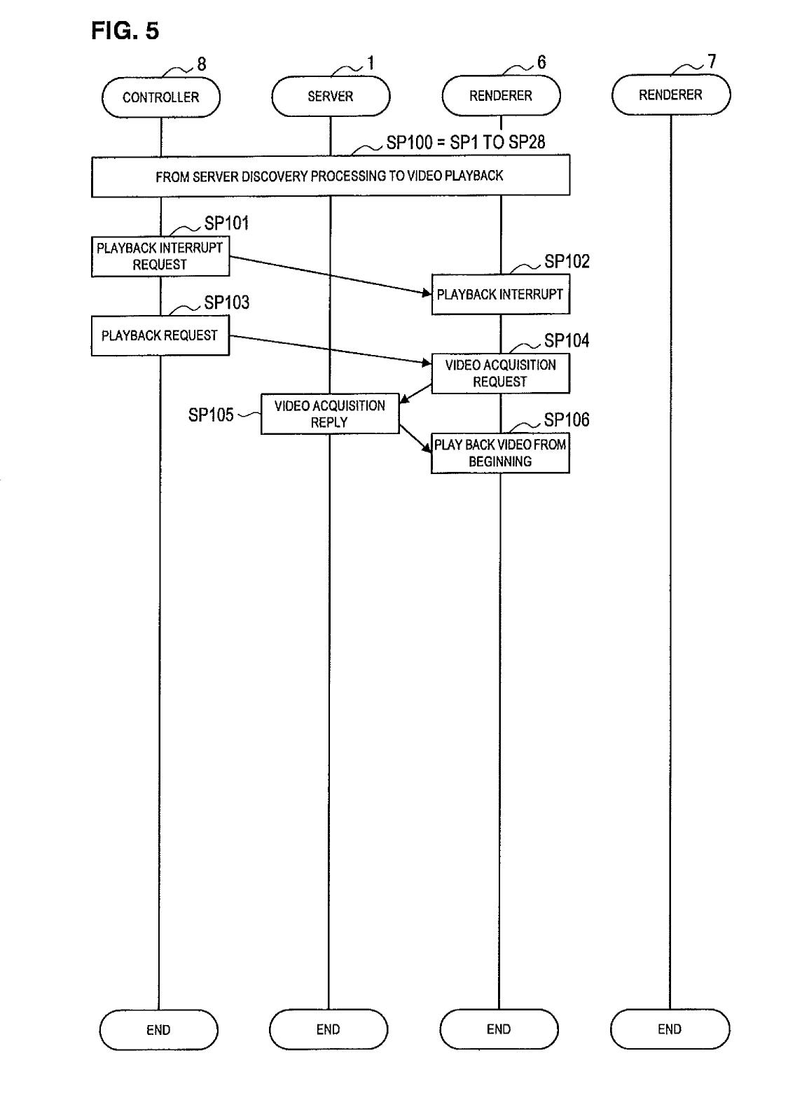

FIG. 5 shows a case in which, in the three-device model in FIG. 2, a playback interrupt request is issued by the controller 8. In this case, the processing from the server discovery to the video playback at Step SP100 is the same as the processing at Steps SP1 to SP28. The video is thus played back by the renderer 6. In a case where the user then interrupts the playback of the video, the controller 8 transmits a playback interrupt request to the renderer 6 at Step SP101. Upon receiving the playback interrupt request, the renderer 6 performs a playback interrupt at Step SP102. In the existing system, a mechanism for recording the playback position at which the playback is interrupted is not provided in any one of the server 1, the controller 8, and the renderer 6. Therefore, when the user causes the controller 8 to transmit a playback request to the renderer 6 at Step SP103 in order to restart the playback, the video acquisition request is transmitted from the renderer 6 to the server 1 at Step SP104, and the video content is transmitted to the renderer 6 as the video acquisition reply at Step SP105. Thus the same sort of processing as at Steps SP25 to SP28 in FIG. 3 is performed in a case where the user restarts the playback. Therefore, at Step SP106, the video is played back from the beginning.

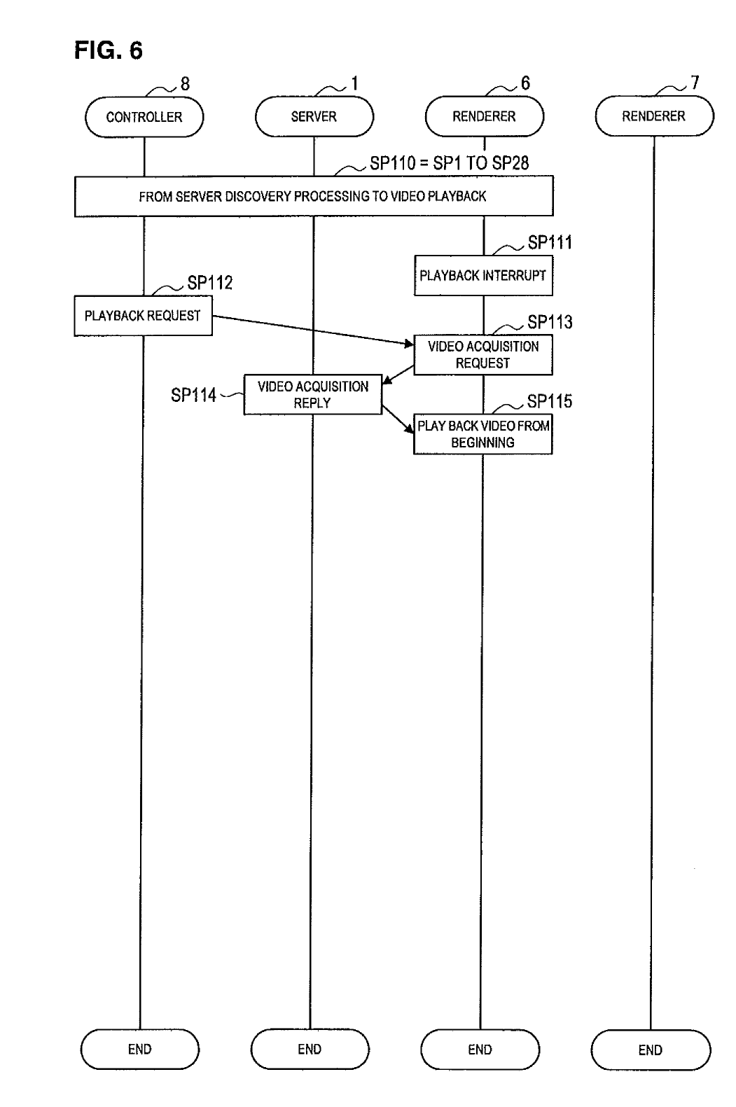

FIG. 6 is a sequence chart that shows a case in which a playback interrupt is performed by the renderer 6. In this case as well, the processing from the server discovery to the video playback at Step SP110 is the same as the processing at Steps SP1 to SP28. The video is thus played back by the renderer 6. Thereafter, the user causes the renderer 6 to perform a playback interrupt at Step SP111 in order to interrupt the playback of the video. When the playback request is then once again transmitted from the controller 8 to the renderer 6 at Step SP112, the video acquisition request is transmitted to the server 1 at Step SP113, and the video acquisition reply is transmitted to the renderer 6 at Step SP114. The video is thus played back from the beginning at Step SP115.

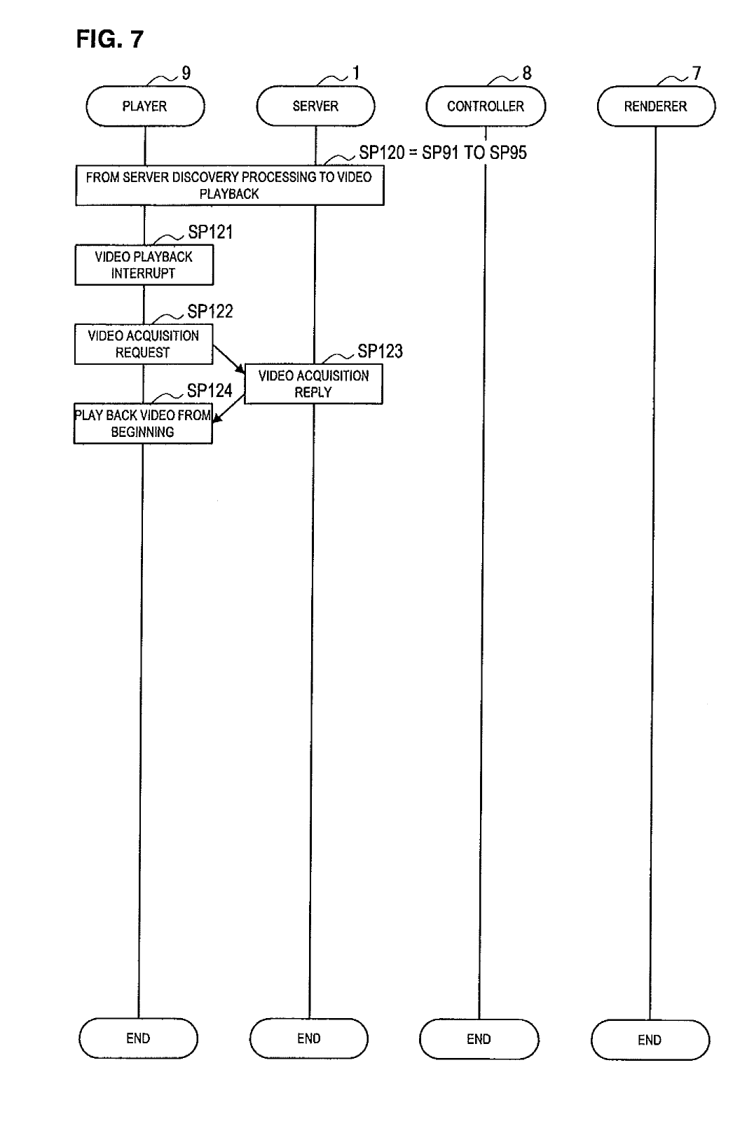

FIG. 7 is a sequence chart that shows a case in which a playback interrupt is performed by the player 9 in the two-device model in FIG. 4. At Step SP120, the processing from server discovery to video playback is performed in the same manner as at Steps SP91 to SP95. The video is thus played back by the player 9. Then a video playback interrupt command is received from the user at Step SP121, and the player 9 performs the playback interrupt. When a playback request is then transmitted from the player 9 to the server 1 at Step SP122, in accordance with a command from the user, the video content is transmitted as the video acquisition reply from the server 1 to the player 9 at Step SP123, and the video is played back from the beginning at Step SP124. Therefore, even in a case where the playback interrupt is performed by the player 9, the video is played back from the beginning when the playback is restarted.

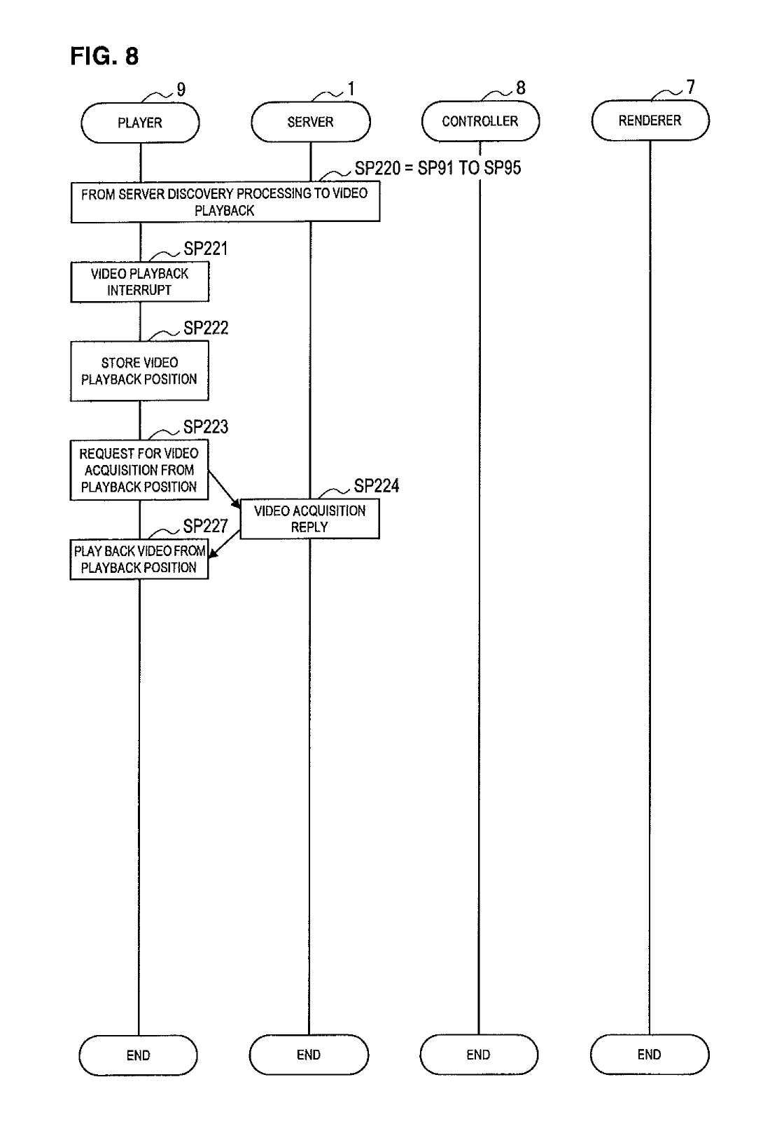

FIG. 8 is a sequence chart that shows a case in which, in the two-device model, the player 9 itself resumes the playback of the video that it was playing back, starting from the position at which the playback was interrupted. At Step SP220, the processing from server discovery to video playback is performed in the same manner as at Steps SP91 to SP95. The video is thus played back by the player 9. Thereafter, at Step SP221, the user performs a playback interrupt on the player 9. Next, also at Step SP221, the video playback on the player 9 is interrupted. Next, at Step SP223, the position at which the video playback was interrupted is stored. Next, when the user issues a command to restart the video playback, a request is transmitted to the server 1 at Step SP223 to acquire the video starting from the position at which the playback was interrupted. Upon receiving the request, the server 1 transmits the video acquisition reply to the player 9, and at Step SP227, the player 9 starts playing back the video from the position at which the video playback was interrupted.

In this manner, the video position at which the playback was interrupted is stored within the player 9 by the processing at Step SP222, and the player 9 is provided with a function that, when the request is made at Step SP223 to play back the video starting from the position at which the playback was interrupted, plays back the video starting from the position at which the playback was interrupted. In the DLNA standard, this sort of playback that starts from the position at which the playback was interrupted can be implemented by describing, at Step SP222, the number of bytes to be played back in the “Range:” field of the Hypertext Transfer Protocol (HTTP) header. However, while this method does make it possible for the player 9 that is provided with this sort of function to perform playback starting from the position at which the playback was interrupted, another player or renderer that is not provided with this sort of function cannot perform playback starting from the position at which the playback was interrupted.

Furthermore, a bookmark function is defined in the Universal Plug and Play (UPnP) AV Content Directory Charter 3. Resuming playback from the position at which the playback was interrupted can thus be accomplished by having the controller transmit to the server 1 information on the position at which the playback was interrupted. However, with this method, it is difficult for everything about the state of one renderer to be reflected in another renderer, and it is necessary for the bookmark function to be implemented in both the renderer and the server. Moreover, does not take into account the case where video playback that starts from the position at which the playback was interrupted is performed by the player.

Furthermore, if unique information pertaining to playback that starts from the position at which the playback was interrupted is added to the server 1, the number of the devices within the system that are capable of utilizing the newly added information must be increased. This is because there are cases in which the server 1 does not have information for determining whether streaming data that have been transmitted to the renderer 6 and the player 9 have been played back on the screens of the renderer 6 and the player 9. It is therefore necessary for the server 1 to have functions for sharing, transmitting, and receiving information on the playback interrupt position with the renderer 6 (or the controller 8) and the player 9, making it necessary to increase the number of the devices within the system that are capable of utilizing the newly added information.

2. Method that Broadcasts Streaming Data

The present embodiment achieves playback that starts from the position at which the playback was interrupted in the system that is described above. In the present embodiment, the methods for achieving this are a method that broadcasts streaming data and a method that utilizes metadata. First, the method that broadcasts streaming data will be explained. This method imposes a greater burden than does the method that utilizes metadata, which will be described later, but it makes it possible for playback that starts from the position at which the playback was interrupted to be implemented with the existing devices. It is therefore possible for playback that starts from the position at which the playback was interrupted to be implemented in the individual devices in the system without replacing all of the devices in the system.

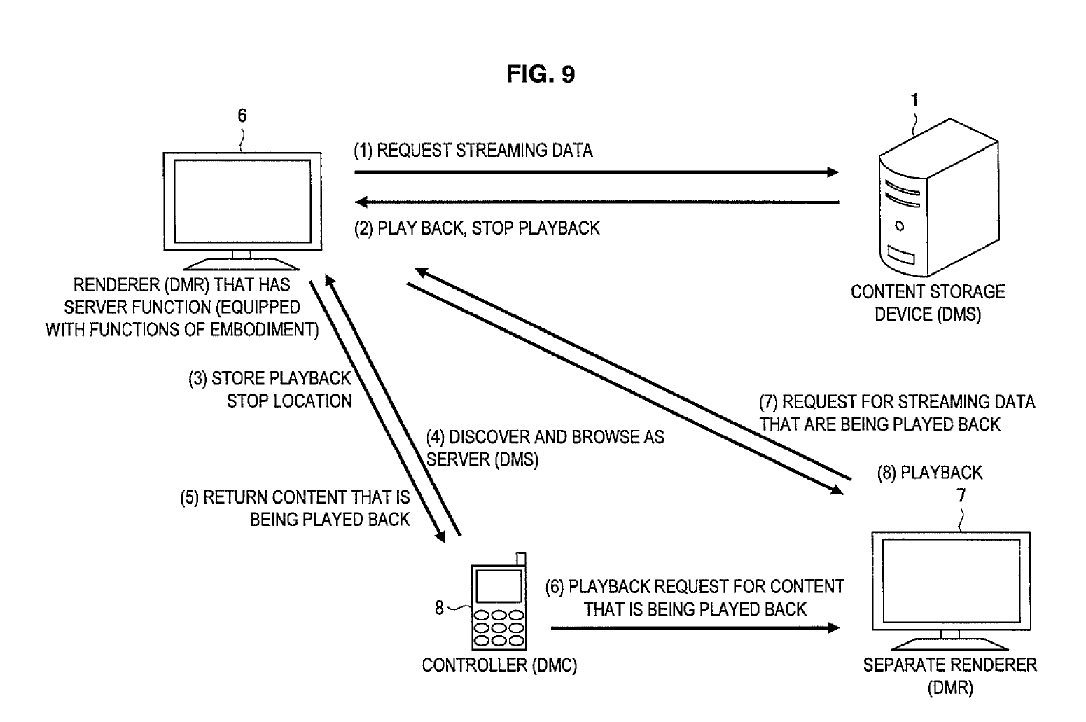

FIG. 9 is a schematic diagram that shows a configuration of a system that uses the method that broadcasts streaming data and also shows an overview of processing. As shown in FIG. 9, the system is configured such that it includes the server 1, the renderer 6, the renderer 7, and the controller 8, and the server 1, the renderer 6, the renderer 7, and the controller 8 are connected through the network 5.

In FIG. 9, the renderer 6 is provided with a server function and is able to broadcast streaming data. The broadcasting processing is performed in accordance with the procedure (1) to (8) in FIG. 9. Assume, for example, that the renderer 6 is located in the living room, and the renderer 7 is located in the bedroom. An example will be explained in which the user plays back a video on the renderer 6 in the living room, but then interrupts the playback, moves to the bedroom, and restarts the playback on the renderer 7 in the bedroom.

First, the user performs playback on the renderer 6 in the living room. At this time, the renderer 6 transmits a request to the server 1 for the streaming data for the video, and the server 1 transmits the streaming data for the video to the renderer 6. The video data that have been transmitted from the server 1 are played back on the renderer 6. Then the playback on the renderer 6 is stopped (interrupted).

The position at which the playback was stopped is stored in the renderer 6. Next, the user, who has moved to the bedroom, uses the controller 8 to broadcast a server discovery request. The renderer 6, which has a server function, replies to the request and transmits to the controller 8 the data for the content for which the playback was interrupted.

Then, when the user operates the controller 8 to request playback of the content for which the playback was interrupted, the renderer 7, upon receiving the playback request, transmits a request to the renderer 6 for the streaming data for which the playback was interrupted. In response, the renderer 6 receives the streaming data for which the playback was interrupted from the server 1 and transmits the data to the renderer 7. This makes it possible for playback to be performed on the renderer 7 starting from the position where the renderer 6 stopped the playback.

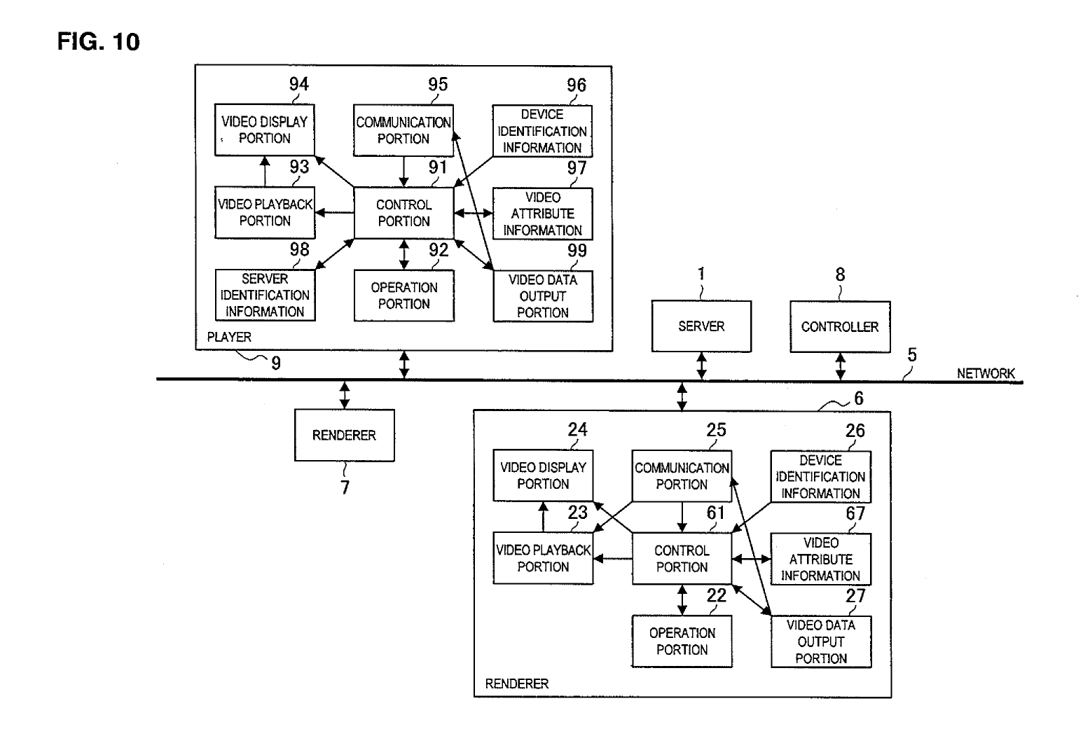

FIG. 10 is a block diagram that shows a configuration of the system of the devices that are connected to a network in a case where the system and the devices use the method that broadcasts streaming data. In FIG. 10, the server 1, the renderer 6, the renderer 7, the controller 8, and the player 9 are connected through the network 5. In this case, the configurations of the renderer 7, the server 1, and the controller 8 are the same as the renderer 7, the server 1, and the controller 8 that were explained in FIG. 1.

However, in the renderer 6, a video data output portion 27 has been added to the renderer 6 in FIG. 1. The video data output portion 27 has the same functions as the video data output portion 13 in the server 1, so the renderer 6 has been configured as a device that has the same functions as the server 1. Based on a command from the control portion 61, the video data output portion 27 transmits designated video data to the communication portion 25.

In the same manner, in the player 9, a video data output portion 99 has been added to the player 9 in FIG. 1. The video data output portion 99 has the same functions as the video data output portion 13 in the server 1, so the player 9 is a device that has the same functions as the server 1. Providing the renderer 6 and the player 9 with the same functions as the server 1 makes it possible to provide the renderer 6 and the player 9 with functions for broadcasting streaming data.

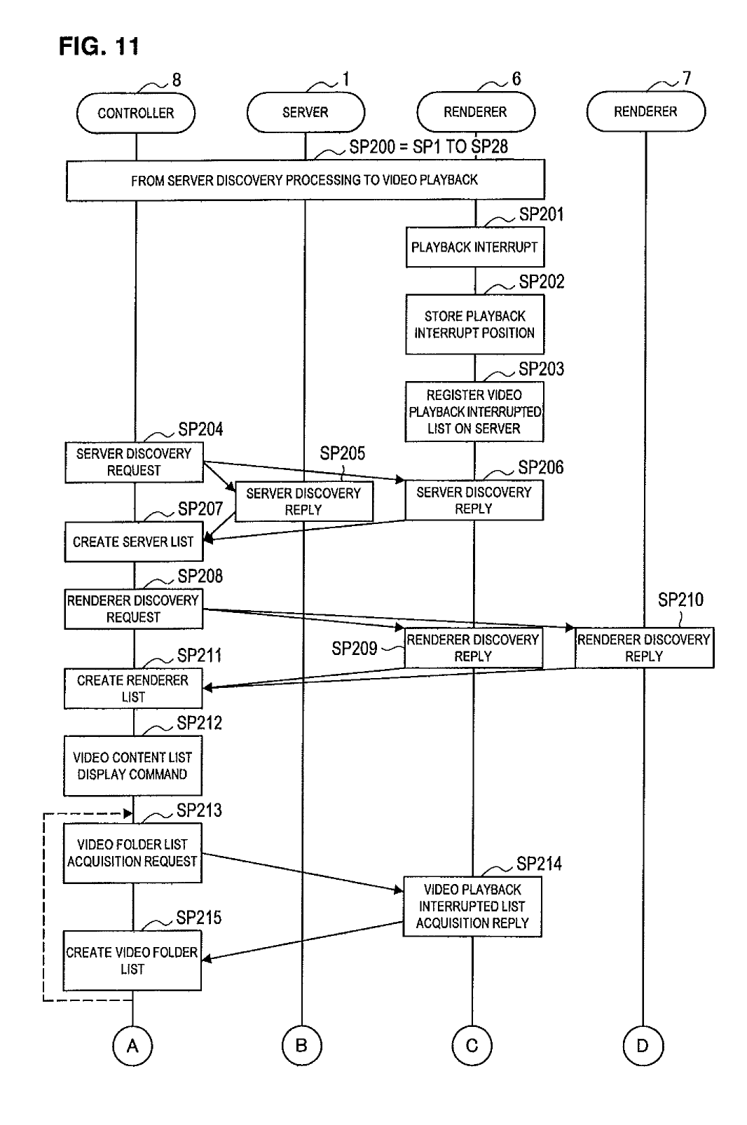

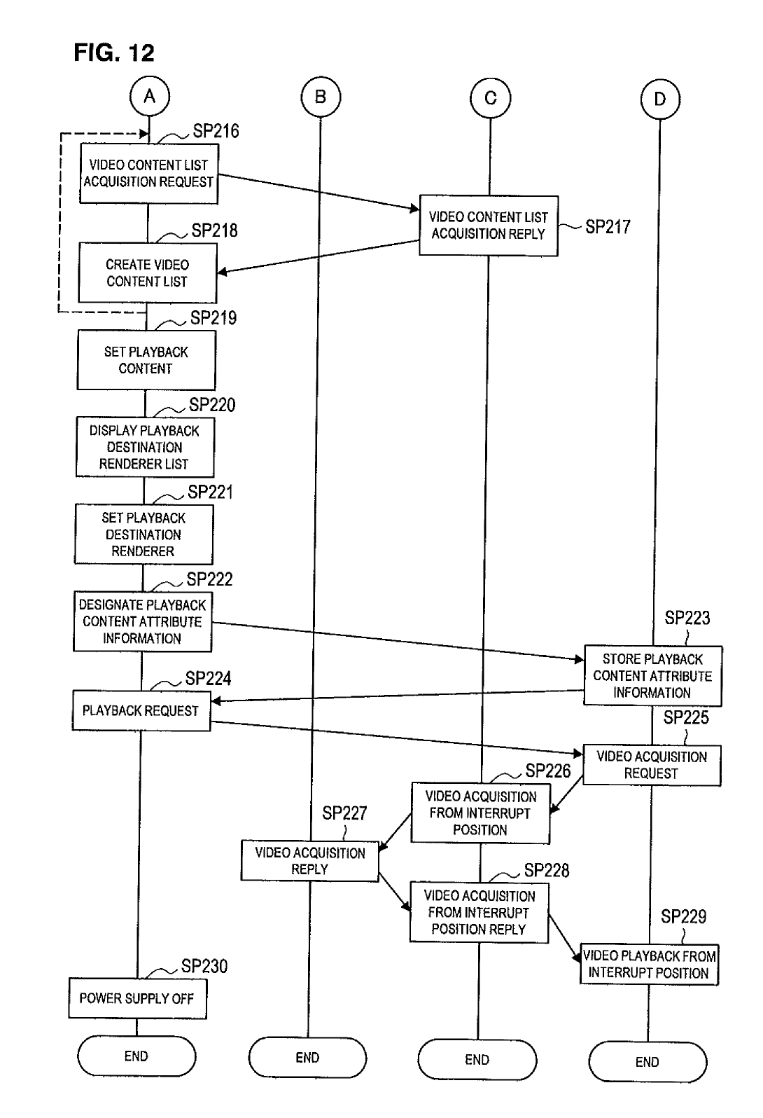

FIGS. 11 and 12 are sequence charts that show a method for implementing video playback that starts from the position where the playback was interrupted, using the renderer 6 that is shown in FIGS. 9 and 10. Step SP200 in FIG. 11 performs the same processing as that at Step SP1 to Step SP28 in FIGS. 2 and 3, from server discovery processing to video playback. At Step SP201 in FIG. 11, the renderer 6 interrupts the video playback in accordance with a command from the user. At Step SP202, the last position in the video for which the playback was interrupted is stored, and at Step SP203, the content list on the server (the server function of the renderer 6) is updated by adding video content information (the video attribute information 67). This causes the content for which the playback was interrupted to be registered in a video playback interrupted list on the server.

Next, when the user uses the controller 8 to make a server discovery request at Step SP204, the renderer 6, which has the server function, transmits a reply to the server discovery request to the controller 8 at Step SP206. Note that the server 1 also transmits a reply to the server discovery request to the controller 8 at Step SP205.

Next, at Step SP207, the controller 8 acquires the replies to the server discovery request from the renderer 6 and the server 1 and creates a server list in the same manner as at Step SP3 in FIG. 2. At that point, the control portion of the controller 8 acquires the device identification information 26 for the renderer 6 and the device identification information 16 for the server 1 and stores them as the server identification information 46.

At Step SP208, the control portion 81 of the controller 8 requests the discovery of the renderers that connected to the network 5, broadcasting a protocol for renderer discovery on the network through the communication portion 45.

At Steps SP209 and SP210, the renderers 6, 7 acquire the renderer discovery protocol that is broadcast on the network 5 and transmit replies to the controller 8, in the same manner as at Steps SP5 and SP6 in FIG. 2.

At Step SP211, the communication portion 45 of the controller 8 acquires the replies to the renderer discovery request from the renderer 6 and the renderer 7 and creates a renderer list. At that point, the control portion 81 acquires the device identification information 26 for the renderer 6 and the renderer 7 and stores them as the renderer identification information 47.

Next, at Step SP212, the user operates the operation portion 42 of the controller 8 in the same manner as at Step SP11 and issues a command to display a list of the video content in the renderer 6.

Next, at Step SP213, the controller 8 performs the same sort of processing as at Step SP12 and transmits to the renderer 6 a request to acquire the list of the video folders in the renderer 6. In the DLNA standard, the Simple Object Access Protocol (SOAP) can be used in the same manner as at Step SP12 above.

At Step SP214, the communication portion 25 of the renderer 6 acquires from the controller 8 the request to acquire the list of the video folders in the renderer 6 and transmits it to the control portion 61. At Step SP214, as a reply to the request, the renderer 6 transmits a video playback interrupted list acquisition reply to the controller 8.

At Step SP215, the communication portion 45 of the controller 8 transmits the video playback interrupted list acquisition reply from the renderer 6 to the control portion 81, and the control portion 81 displays on the display portion 44 the names and the like of the video content for which the playback has been interrupted. The user looks at the display on the display portion 44 and uses the operation portion 42 to select the video folder he wants to see.

Thereafter, as shown from Step SP216 to Step SP224, the video information that has been acquired from the renderer is transmitted to the renderer 6, and a video playback request is made. First, at Step SP216, in accordance with a signal from the operation portion 42 that is generated by a user operation, the control portion 81 of the controller 8 transmits to the renderer 6, through the communication portion 45, a request to acquire a list of the video content in the renderer 6.

At Step SP217, the communication portion 25 of the renderer 6 acquires the request from the controller 8 to acquire the list of the video content and transmits the request to the control portion 61. The control portion 61 then acquires, from the attribute information 67, the attribute information (the attribute information 67) for the video content that the renderer 6 has. The control portion then transmits the attribute information as a video content list acquisition reply to the controller 8 through the communication portion 25.

At Step SP218, the communication portion 45 of the controller 8 takes the video content list acquisition reply that has been transmitted from the renderer 6 and transmits it to the control portion 81. The control portion 81 displays the titles and the like of the video content on the display portion 44.

At Step SP219, the user uses the operation portion 42 to select the video content he wants to play back. The video content the user wants to play back is set by the controller 8 by the processing described above at Step SP212 to Step SP219.

At Step SP220, the control portion 81 of the controller 8 displays a list of the playback destination renderers on the display portion 44. Next, at Step SP221, the user sets the playback destination renderer by operating the operation portion 42. In this case, the renderer 7 is set as the playback destination renderer.

Next, at Step SP222, the attribute information for the content that will be played back is designated. In this case, the user is able to designate the content for which the playback was interrupted and that is registered in the video playback interrupted list. The attribute information designation is transmitted to the renderer 7, which is the playback destination. At Step SP223, the renderer 7 stores the video content attribute information and transmits information to that effect to the controller 8.

At Step SP224, the controller 8 transmits a playback request to the renderer 7. Upon receiving the playback request, the renderer 7 transmits a video acquisition request to the renderer 6 at Step SP225. Upon receiving the video acquisition request, the renderer 6 transmits to the server 1, at Step SP226, a request for video acquisition starting from the position where the playback was interrupted. In doing so, the renderer 6 transmits to the server 1 the request for video acquisition starting from the position where the playback was interrupted, based on the playback interruption position that was stored at Step SP202.

Upon receiving from the renderer 6 the request for video acquisition starting from the position where the playback was interrupted, the server 1 transmits a video acquisition reply to the renderer 6 at Step SP227. In this case, based on the position at which the playback was interrupted, the server 1 transmits the video data to the renderer 6 starting from the position at which the playback was interrupted. Upon receiving the video acquisition reply from the server 1, the renderer 6 transmits the video acquisition reply (the video data starting from the position at which the playback was interrupted) to the renderer 7 at Step SP228. The renderer 7 then performs the playback at Step SP229, starting from the position at which the playback was interrupted.

Thus, in the processing in FIG. 12, the playback destination renderer 7 transmits the video acquisition request to the renderer 6 at Step SP225. Having received the video acquisition request, the renderer 6 acquires the video by designating the range in the HTTP from the server 1 at Step SP226. At Step SP227, the server 1 sends back the video for the designated range as a reply. At Step SP228, the video data output portion 27 of the renderer 6, under the control of the control portion 61, transmits to the renderer 7 the video data that have been received from the server 1. Therefore, at Step SP229, playback that starts from the position where the playback was interrupted can be achieved by the renderer 7.

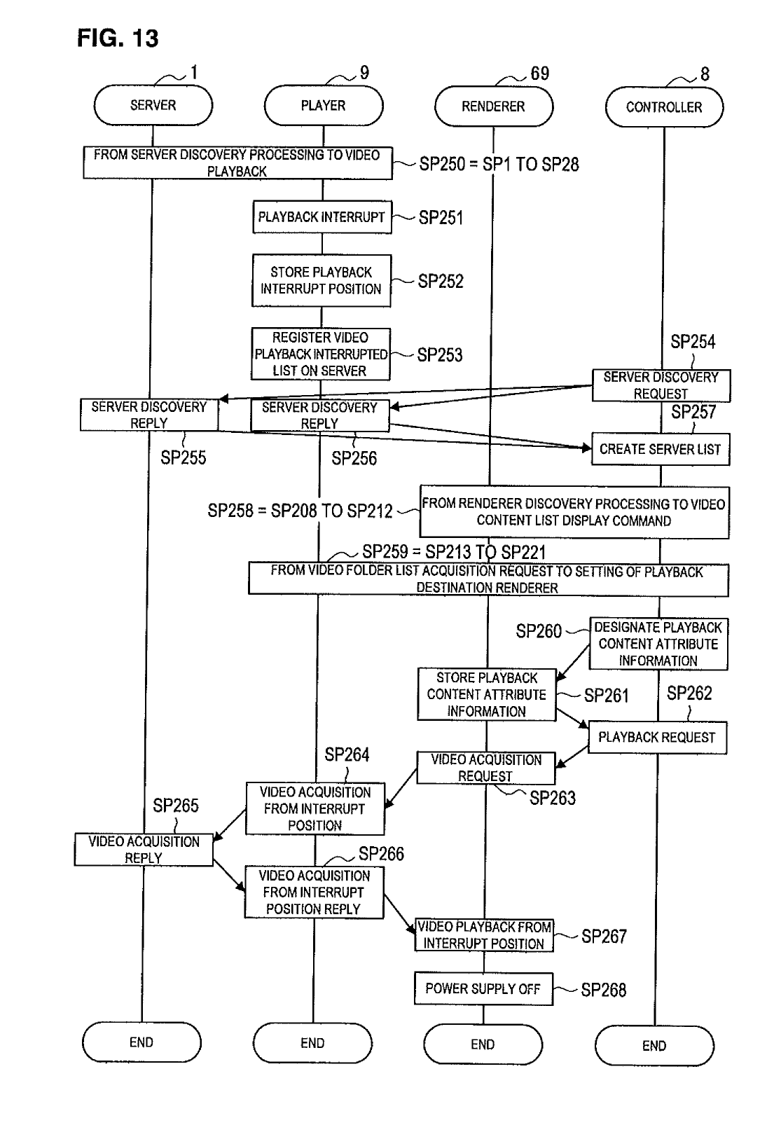

FIG. 13 is a sequence chart that shows the method for implementing the playback of a video from the position at which the playback was interrupted, using the player 9, that was explained by FIG. 9, and it corresponds to the two-device model that was explained by FIG. 4. In this case, the player 9, the server 1, a renderer 69, and the controller 8 are connected through the network 5. First, at Step SP250, the processing from server discovery to video playback is performed in the same manner as at Steps SP1 to SP28 (in the same manner as at Steps SP91 to SP95). Playback of the video is thus performed by the player 9.

In a case where the user then interrupts the playback of the video, the playback by the player 9 is interrupted at Step SP251. This happens when the user inputs a playback interrupt command from the operation portion 92, and the player 9, upon receiving the command, interrupts the playback. Next, the player 9 stores the playback interrupt position at Step SP252. Next, at Step SP253, the player 9 registers the fact that the playback has been interrupted in the video playback interrupted list on the server 1.

Next, when the user operates the controller 8 in order to play back the video from the position at which the playback was interrupted, the controller 8 transmits a server discovery request at Step SP254 by broadcasting a server discovery protocol over the network 5. At Step SP255, the server 1 transmits a reply to the server discovery request to the controller 8. The player 9 is also provided with the server functions, as described previously, so at Step SP256, the player 9 also transmits a reply to the server discovery request to the controller 8. At Step SP257, the controller 8 creates the server list.

At Step SP258, the same sort of processing as at Steps SP208 to SP212, from the renderer discovery processing to the video content list display command, is performed. Then at Step SP259, the same sort of processing as at Steps SP213 to SP221, from the video folder list acquisition request to the setting of the playback destination renderer, is performed.

At Step SP260, the attribute information is designated in the controller 8 for the content that will be played back. Next, at Step SP261, attribute information for the playback content is stored in the renderer 69. Next, at Step SP262, a playback request is transmitted from the controller 8 to the renderer 69. Upon receiving the playback request, the renderer 69 transmits a video acquisition request to the player 9 at Step SP263.

Upon receiving the video acquisition request from the renderer 69, the player 9, at Step SP264, transmits to the server 1 a request to acquire the video starting from the position at which the playback was interrupted. Upon receiving the request, the server 1 transmits a video acquisition reply to the player 9 at Step SP265. The player 9, having received the reply, transmits to the renderer 69, at Step SP266, a reply for video acquisition starting from the position at which the playback was interrupted. At Step SP267, the renderer 69 performs video playback starting from the position at which the playback was interrupted. Thereafter, when the video playback is completed, the power supply for the renderer 69 is turned off at Step SP268.

In the processing in FIG. 13, as described above, the playback is interrupted at Step SP251, and at Step SP252 and Step SP253, the last position of the video that was being played back is stored and the content list on the server is updated by the addition of the interrupted video. This makes it possible for the controller 8 to recognize the player 9 as the server at Step SP254, to select the video to be played back starting from the position at which the playback was interrupted, and to request playback. Thereafter, the processing is the same as in FIGS. 11 and 12.

### 3. Method That Adds Information on Resuming Playback to Metadata

Next, the method that adds information on resuming playback to metadata in order to achieve playback that starts from the position where the playback was interrupted will be explained. This method makes it possible to implement playback that starts from the position where the playback was interrupted with less of a burden, but it presumes that a system such as that described below has been implemented in the device that performs the playback that starts from the position where the playback was interrupted. In the DLNA standard, the Simple Object Access Protocol (SOAP) is used, and specifically, the attribute information for the video content can be acquired by using the command called CDS: Browse. In the present embodiment, playback that starts from the position where the playback was interrupted is implemented by adding information (relativeTimePosition) that pertains to the playback position of the video to the attribute information.

The metadata can be data like that shown below, for example. In this case, relativeTimePosition is the information on the playback position of the video.

<res size=&quot; size&quot; bitrate=&quot; bitrate&quot; duration=&quot; duration&quot; protocollnfo=&quot; http-get:*:video/mpeg:DLNA protocollnfo&quot; resolution=&quot; resolution&quot; relativeTimePosition=&quot; relativeTimePosition&quot; >video location information (URL)</res>

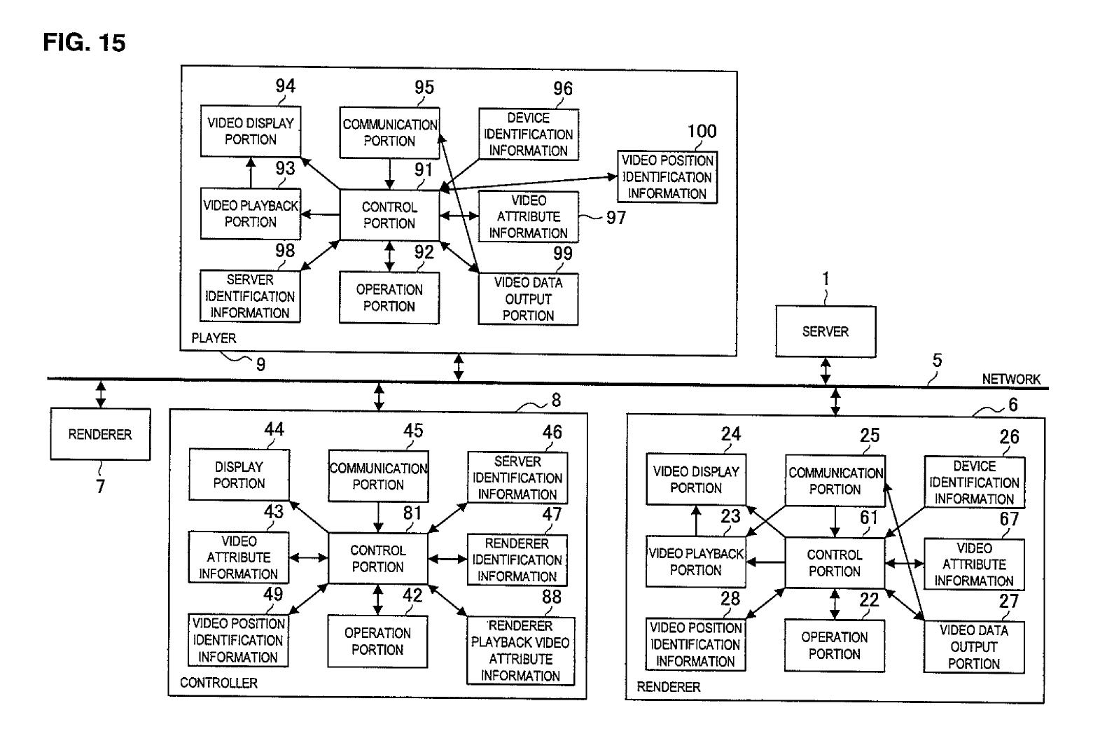

FIG. 15 is a block diagram that shows a configuration of the system of the devices that are connected to a network in a case where the system and the devices use the method that utilizes metadata. In FIG. 15, the server 1, the renderer 6, the renderer 7, the controller 8, and the player 9 are connected through the network 5. In this case, the configurations of the renderer 7 and the server 1 are the same as those of the renderer 7 and the server 1 that were explained by FIG. 1.

Furthermore, unlike in FIG. 9, in FIG. 15 video position identification information acquisition portions 100, 28, and 49 have been added to the player 9, the renderer 6, and the controller 8, respectively. In the devices that receive the attribute information for the video content (the player 9, the renderer 6, and the controller 8), the respective video position identification information acquisition portions 100, 28, and 49 acquire the information (relativeTimePosition) that pertains to the playback position and by analyzing the information, determine whether the video is one for which the playback has been interrupted.

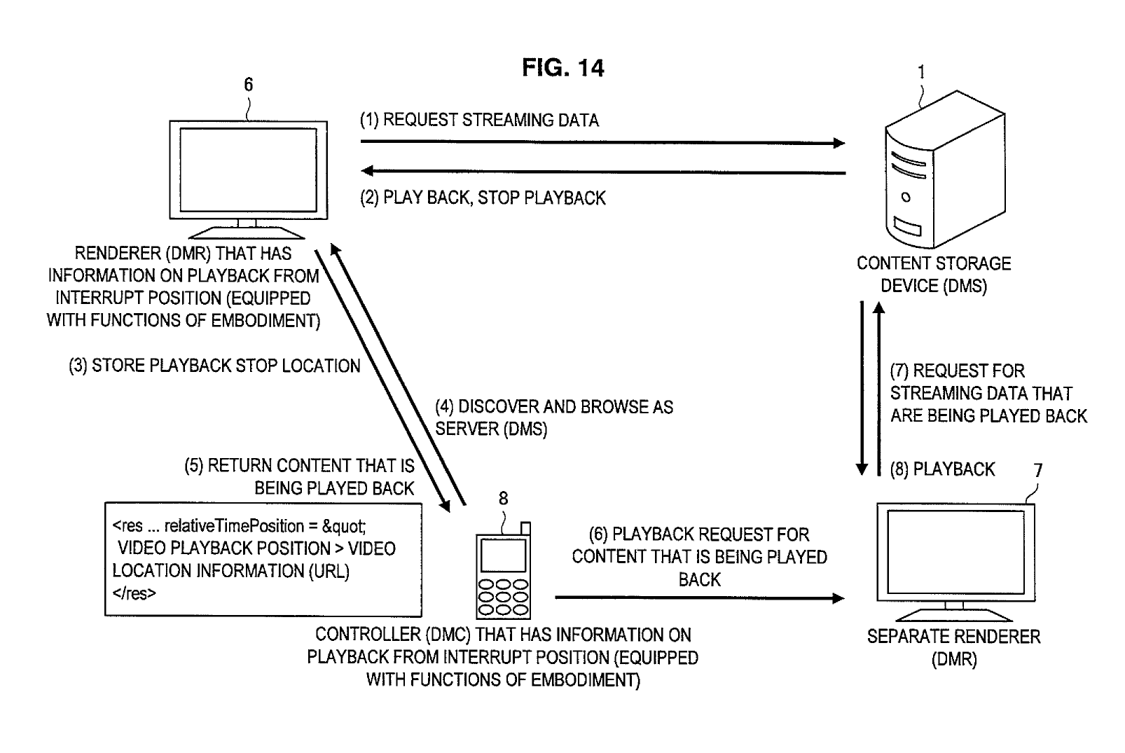

FIG. 14 is a schematic diagram that shows a configuration of a system that uses the method that utilizes metadata and also shows an overview of processing. As shown in FIG. 14, the system is configured such that it includes the server 1, the renderer 6, the renderer 7, and the controller 8, and the server 1, the renderer 6, the renderer 7, and the controller 8 are connected through the network 5.

In FIG. 14, the renderer 6 is able to transmit to the controller 8, as metadata, information on the video that is being played back. The processing involved in playback is performed in accordance with the procedure (1) to (8) in FIG. 14. In this case as well, assume, for example, that the renderer 6 is located in the living room, and the renderer 7 is located in the bedroom. An example will be explained in which the user plays back a video on the renderer 6 in the living room, but then interrupts the playback, moves to the bedroom, and restarts the playback on the renderer 7 in the bedroom.

First, the user performs playback on the renderer 6 in the living room. At this time, the renderer 6 transmits a request to the server 1 for the streaming data for the video, and the server 1 transmits the streaming data for the video to the renderer 6. The video data that have been transmitted from the server 1 are played back on the renderer 6. Then the playback on the renderer 6 is stopped (interrupted).

The position at which the playback was stopped is stored in the renderer 6. Next, the user, who has moved to the bedroom, uses the controller 8 to broadcast a server discovery request. The renderer 6, which has a server function, replies to the request and transmits to the controller 8 the data for the content for which the playback was interrupted, including the position at which the playback was stopped.

Then, when the user operates the controller 8 to request playback of the content for which the playback was interrupted, the renderer 7, upon receiving the playback request, transmits a request to the server 1 for the streaming data for which the playback was interrupted. In response, the server 1 transmits the streaming data for which the playback was interrupted to the renderer 7. This makes it possible for playback to be performed on the renderer 7 starting from the position where the renderer 6 stopped the playback.

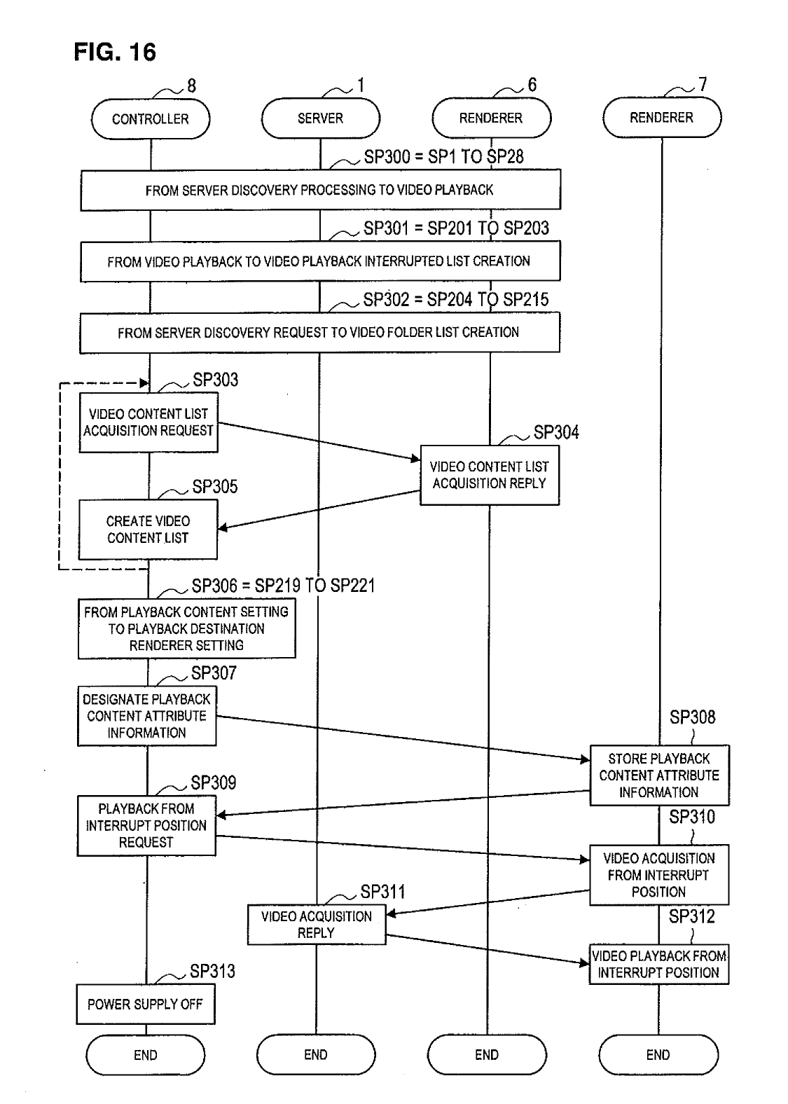

FIG. 16 is a sequence chart that shows processing in a case in which the video position identification information acquisition portions 28 and 49 have been added to the renderer 6 and the controller 8, respectively. In FIG. 16, Step SP300 is the same as Steps SP1 to SP28, Step SP301 is the same as Steps SP201 to SP203, and Step SP302 is the same as Steps SP204 to SP215.

At Steps SP300, SP301, the controller 8 performs the server discovery, and in the renderer 6, the playback and the interrupting of the playback of the video from the server 1 (in the same manner as at Step SP201), and the storing of the playback interrupt position (in the same manner as at Step SP202) are completed. At Step SP302, the renderer 6 functions as a server and transmits the video playback interrupted list to the controller 8 (in the same manner as at Step SP214).

At Step SP303, the controller 8 transmits to the renderer 6 a request to acquire a list of the video content on the renderer 6. At Step SP304, the renderer 6 transmits to the controller 8 a reply to video content list acquisition request. In this process, the information that the video position identification information acquisition portion 28 has acquired on the position where the playback was interrupted is transmitted to the controller 8. At Step SP305, the controller 8 creates the video content list. Thus, from Step SP303 to Step SP305, the renderer 6 transmits the video content list to the controller 8 and also transmits to the controller 8 the information on the position where the playback was interrupted (relativeTimePosition).

At Step SP306, the same sort of processing as at Steps SP219 to SP221 in FIG. 12, from the playback content setting to the playback destination renderer setting, is performed. At Step SP307, the user uses the controller 8 to designate the playback content attribute information. At Step SP308, the renderer 7 stores the playback content attribute information.

At Step SP309, based on the information on the position where the playback of the video was interrupted, the controller 8 transmits to the renderer 7 a request to play back the video starting from the position where the playback was interrupted. The request to play back the video starting from the position where the playback was interrupted can be made using the SetAVT, Seek, and Play commands that are defined by the DLNA standard. At Step SP310, the renderer 7, having received the request to play back the video starting from the position where the playback was interrupted, transmits to the server 1 a request for video acquisition starting from the position where the playback was interrupted, based on the information on the position where the playback was interrupted. At Step SP311, the server 1 transmits a video acquisition reply to the renderer 7 in response to the request for video acquisition starting from the position where the playback was interrupted. At Step SP312, the renderer 7, upon receiving the video acquisition reply, performs the playback starting from the position where the playback was interrupted. Thus the renderer 7 is able to play back the video that it has acquired from the server 1, starting from the position where the playback was interrupted.

In the processing in FIG. 16, the device that transmits the playback request is the server 1 instead of the renderer 6. Therefore, unlike in FIG. 12, the renderer 6 does not have to interrupt the streaming of the video from the server 1, so the burden on the renderer 6 can be reduced.

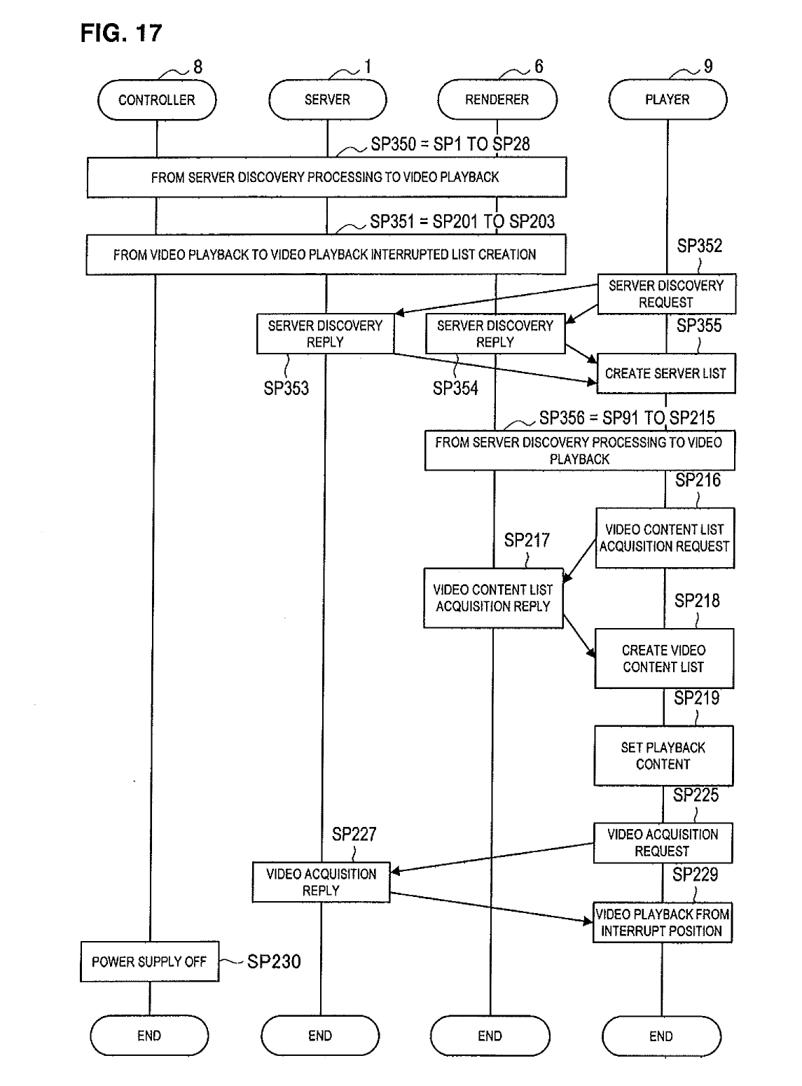

FIG. 17 is a sequence chart that shows processing in a case in which the video position identification information acquisition portions 28, 100 have been added to the renderer 6 and a player 9, respectively. In FIG. 17, Step SP350 is the same as Steps SP1 to SP28, and Step SP351 is the same as Steps SP201 to SP203.

When the player 9 transmits a server discovery request at Step SP352, the server 1 and the renderer 6 each transmit a reply to the server discovery request to the player 9 at Step SP353 and SP354, respectively. At Step SP355, the player 9 creates the server list.

At Step SP356, the processing from the server discovery processing to the video playback is performed, in the same manner as at Steps SP91 to SP215. At Step SP216, a video content list acquisition request is transmitted from the player 9 to the renderer 6. At Step SP217, a reply to the video content list acquisition request is transmitted from the renderer 6 to the player 9. At Step SP218, the player 9 creates the video content list.

At Step SP217 and Step SP218, the transfer of the information on the position where the playback was interrupted (relativeTimePosition) is carried out between the renderer 6 and the player 9 in the same manner as in FIG. 16. This makes it possible for the player 9 to transmit to the server 1 a request to play back the video starting from the position where the playback was interrupted.

Next, at Step SP219, the player 9 sets the playback content. Once the playback content is set at Step SP219, a video acquisition request is transmitted from the player 9 to the server 1 at Step SP225. In this case, the video acquisition request is for playback that starts from the position where the playback was interrupted, based on the information on the position where the playback was interrupted. At Step SP227, a reply to the video acquisition request is transmitted from the server 1 to the player 9. At Step SP229, the player 9 performs the playback starting from the position where the playback was interrupted. At Step SP230, the power supply to the controller 8 is turned off.

According to the processing in FIGS. 16 and 17, as described above, it is possible for the device that performs the playback that starts from the position where the playback was interrupted to implement that type of playback in a simple configuration by transmitting the playback request using the information that pertains to the position where the playback was interrupted.

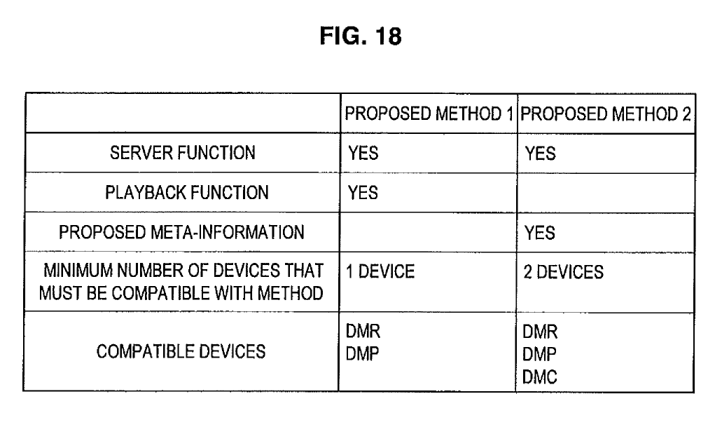

FIG. 18 is a schematic diagram that shows a comparison of the method that broadcasts the streaming data (shown as method 1 in FIG. 18) and the method that appends to the metadata information that pertains to playback that starts from the position where the playback was interrupted (shown as method 2 in FIG. 18). With each of the methods, playback that starts from the position where the playback was interrupted can be implemented without replacing all of the devices in the existing system. As shown in FIG. 18, both method 1 and method 2 presume that any replacement device will have functions similar to those of the server 1. Furthermore, the replacement device in method 1 (the renderer 6) has a playback function. The replacement device in method 2 has information about the metadata.

The minimum number of devices that must be compatible with the functions of method 1 is one (the renderer 6), and the minimum number of devices that must be compatible with the functions of method 2 is two (the renderers 6, 7). Specifically, the devices that are able to be compatible with the functions of method 1 are the DMR and the DMP, and the devices that are able to be compatible with the functions of method 2 are the DMR, the DMP, and the DMC.

According to the present embodiment as explained above, playback that starts from the position where the playback was interrupted can be implemented on a different device by using a renderer, a player, and a controller that have the functions of the present embodiment to transmit and receive additional information that pertains to the position where the playback was interrupted. In a case where the functions of the present embodiment are implemented in only one of the renderer and the player, playback of the video for which the playback was interrupted can be implemented on a different device, starting from the position where the playback was interrupted, by interrupting the streaming of data from the server. Furthermore, because the renderer and the player are provided with the same sort of functions as the server, content that has been played back by the renderer or the player can be stored in a root container, and a list of stored content can be displayed, making it easier to access the content from another device.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device, comprising:
a display portion that displays video content that has been received from a server that stores the video content;
a storage portion that stores a playback interruption position for the video content; and
a video output portion that, in a case where a video acquisition request is received from another device that will restart playback of the video starting from the playback interruption position, acquires the video content from the server, starting from the playback interruption position, and transmits the acquired video content to the other device.

2. An information processing device, comprising:
a display portion that displays video content that has been received from a server that stores the video content;
a playback interruption position acquisition portion that acquires a playback interruption position for the video content; and
a communication portion that, in order to restart playback of the video by another device, starting from the playback interruption position, transmits information on the playback interruption position to a controller that operates the other device.

3. An information processing method, comprising:
displaying video content that has been received from a server that stores the video content;
storing a playback interruption position for the video content; and
acquiring the video content from the server, starting from the playback interruption position, in a case where a video acquisition request is received from another device that will restart playback of the video starting from the playback interruption position, and transmitting the acquired video content to the other device.

4. An information processing method, comprising:
displaying video content that has been received from a server that stores the video content;
acquiring a playback interruption position for the video content; and
a communication portion that, in order to restart playback of the video by another device, starting from the playback interruption position,
transmitting information on the playback interruption position to a controller that operates another device, in order to restart playback of the video by the other device, starting from the playback interruption position.

5. An information processing system, comprising:
a server that stores video content;
a first information processing device that includes a display portion that displays video content that has been received from the server, a storage portion that stores a playback interruption position for the video content, and a video output portion that, in a case where a video acquisition request is received from a second information processing device that will restart playback of the video starting from the playback interruption position, acquires the video content from the server, starting from the playback interruption position, and transmits the acquired video content to the second information processing device; and
the second information processing device that receives the video content from the first information processing device, starting from the playback interruption position, and that performs the playback of the video starting from the playback interruption position.

6. An information processing system, comprising:
a server that stores video content;
a first information processing device that includes a display portion that displays video content that has been received from the server, a playback interruption position acquisition portion that acquires a playback interruption position for the video content, and a communication portion that, in order to restart playback of the video by a second information processing device, starting from the playback interruption position, transmits information on the playback interruption position;
a controller that receives the information on the playback interruption position and transmits the information on the playback interruption position to the second information processing device; and
the second information processing device that receives the information on the playback interruption position from the controller and that receives the video content from the server, starting from the playback interruption position, based on the information on the playback interruption position.
